(19) United States
(12) Patent Application Publication
(10) Pub. No.: US 2007/0009398 A1
(43) Pub. Date: Jan. 11, 2007

(54) Waste gas cleaning system for an internal combustion engine

(75) Inventors: Frank Duvinage, Kirchheim (DE); Berthold Keppeler, Owen (DE); Leopold Mikulic, Weinstadt (DE); Arno Nolte, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/562,228

(22) PCT Filed: Jun. 16, 2004
(86) PCT No.: PCT/EP04/06468

§ 371 Date: Jun. 20, 2006

(30) Foreign Application Priority Data
Jun. 26, 2003 (DE) 103 28 678.0

(51) Int. Cl. B01D 53/34

(52) U.S. Cl. 422/168; 422/171

(57) ABSTRACT

The invention concerns an exhaust gas cleaning system for an internal combustion engine with at least one catalytically active component which is configured such that its catalytically active coating comprises at least a first region with high light-off temperature and a high temperature resistance and at least a second region with a low light-off temperature and a reduced temperature resistance (relative to the first region). The exhaust-gas-side surface of the catalytically active coating in the intake region of the catalytically active component has at least a partial diffusion layer, or is at least partially covered by a diffusion layer.

### BACKGROUND AND SUMMARY OF THE INVENTION

The invention concerns an exhaust gas catalyst system for an internal combustion engine, with at least one catalytically active component.

Catalytic converters ordinarily have a relatively restricted optimal thermal functioning range for ensuring proper cleaning of exhaust gas. In the case of NOx storage catalytic converters, for example, the optical range is between 190° C. and 500° C. Below this range, they are not yet sufficiently catalytically active to be fully functional and to store the undesired pollutants contained in the exhaust gas and/or convert them into harmless substances; while above this range, a very strong deactivation is associated with a strong thermal aging, which results ultimately in the destruction of the catalytic converter due to overheating. Since the temperature of the catalytic converter is determined essentially by the temperature of the exhaust gases flowing through it, control, (in particular limiting) of the exhaust gas temperature through mechanical means and/or targeted cooling of exhaust gas is therefore of special importance for the proper operation of exhaust gas catalytic converters. No less important, however, is also the thermic behavior of the exhaust gas catalytic converters themselves; that is: good temperature resistance in ranges of relatively high exhaust gas temperatures or good light-off performance in order to be able to quickly reach their full catalytic activity so that efficient cleaning of exhaust gas is ensured.

A method for the treatment of exhaust gases of a diesel engine for the reduction of particle emissions is disclosed in German patent document DE 197 18 727 C2, in which the diesel exhaust gas is directed through two diesel catalytic converters arranged one behind the other, with the cell density of the downstream, second catalytic converter being greater than that of the first catalytic converter.

One object of the present invention is to provide an exhaust gas cleaning system for an internal combustion engine, especially for a diesel engine, in which reaction heat conversion is distributed uniformly over the entire length of the catalytically active components and aging behavior is improved.

This and other objects and advantages are achieved by the exhaust gas cleaning system according to the invention, in which the exhaust-gas-side surface of the catalytically active coating in the intake region of the catalytically active components has at least a partial diffusion layer, or is at least partially covered by a diffusion layer.

In a refinement of the exhaust gas cleaning system according to the invention, the at least one region with high light-off temperature and a high temperature resistance (in contrast to the at least one other region with a low light-off temperature a reduced temperature resistance in comparison to the former) has a lower specific noble metal content and/or a larger noble metal particle diameter.

In another advantageous embodiment, the cell density in the intake region (higher and/or intermediate temperature region) of the catalytically active component is lower than in the discharge region (lower temperature region) of the catalytically active component.

According, another feature of the invention, the catalytically active component is configured in its intake region with a support material that has a higher specific heat capacity, and in its discharge region with a support material with a lower specific heat capacity. As a result, a deactivation of the catalytic converter induced by a hot spot can be suppressed in a most advantageous manner, while at the same time good light-off behavior can be achieved. For example, ceramic or ceramic-containing materials and/or metals or metal-containing materials as well as other materials suited to the particular application purpose can advantageously be used as supporting materials with differing specific heat capacity.

In an alternative refinement of the invention according, the catalytically active component has a cone shape.

Furthermore, in another embodiment of the invention, the catalytically active coating is in multiple layers, with the individual layers having differing composition. The at least one region with high light-off temperature in combination with a high temperature resistance is oriented toward the exhaust gas side, and the at least one additional region with a low light-off temperature in combination with reduced temperature resistance in comparison with the at least one region, is applied to the side oriented away from the exhaust gas. The start-up temperature of a catalytically active component is referred to as light-off temperature.

In a preferred embodiment of the invention, the catalytically active coating with at least one region of high light-off temperature and with at least one further region with a low light-off temperature is applied in the form of a gradient, with the high light-off temperature being applied predominantly in the intake region of the catalytically active component and predominantly the at least one other region, with a lower light-off temperature being applied in the discharge region of the catalytically active component.

In a further preferred embodiment, the catalytically active coating includes predominantly or entirely the at least one further region with a low light-off temperature in combination with reduced temperature resistance.

The catalytically active component can, for example, be configured as an oxidation catalytic converter, an NOₓ storage catalytic converter, an SCR catalytic converter and/or as a particle filter.

Further advantages of the invention will become evident from the description and from the drawing. Exemplary embodiments of the invention are illustrated in a simplified form in the drawing and will be explained in more detail in the following description. In the drawing:

### BRIEF DESCRIPTION OF THE DRAWINGS

FIG. 1 is a schematic depiction of a first embodiment of the invention

FIG. 2 is a schematic depiction of a second embodiment of the invention

FIG. 3 is a schematic depiction of a third embodiment of the invention

FIG. 4 shows the conversion behavior of an NOₓ storage catalytic converter according to the state of the art

FIG. 5 shows an optimized conversion behavior of an NOₓ storage catalytic converter according to the invention.

### DETAILED DESCRIPTION OF THE DRAWINGS

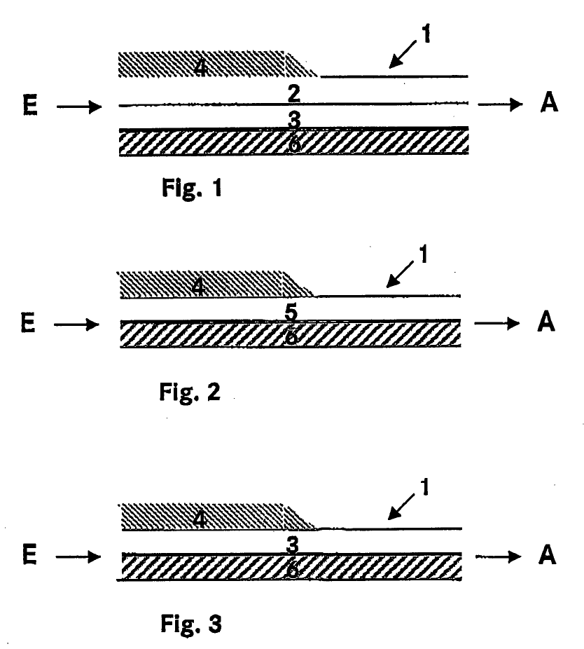

The schematic depiction of FIG. 1 shows an arrangement of a catalytically active coating 1 using the example of an NOₓ storage catalytic converter. Exhaust gas catalytic converters ordinarily comprise a support material or a support body 6 with catalytically active coating 1 applied thereto. The latter, for example, can be applied to the support body by means of a porous washcoat of Al₂O₃, SiO₂, TiO₂, ZrO₂, zeolites and/or mixtures thereof together with activity enhancing additives or promoters. Frequently serving as support body for catalytic converters are ceramic catalytic converters with a honeycomb-like structures, preferably of cordierite or other suitable materials. Alternatively, however, support bodies of metal can also be used. Furthermore, the catalytically active component can be configured in its intake region with a support material with higher specific heat capacity and with a support material with lower specific heat capacity in its discharge region so that materials such as, for example, metal or metal-containing materials and ceramic or ceramic-containing material can be jointly utilized as support material or support body for a catalytic component.

As depicted in FIG. 1, the catalytically active coating 1 of the NOₓ storage catalytic converter is constructed of individual layers of differing composition. The at least one region with a high light-off temperature and a high temperature resistance 2 is directed toward the exhaust side, and the at least one other region with a low light-off temperature and a reduced temperature resistance 3 (compared with the at least one region being applied to the side directed away from the exhaust gas). Region 2 thus is characterized in comparison with region 3 by a poorer low-temperature activity, but a higher high-temperature resistance, while region 3 in contrast has an opposite behavior and is responsible for good overall conversion and good cold-start behavior. Through the incorporation of region 2 in the intake region of the catalytically active component, the activity in the lower and/or intermediate temperature range is reduced.

Regions 2 and 3 contain platinum-group metals, in particular platinum and/or rhodium, as catalytic converter material, as well as alkali or earth alkali metals, which are characterized by their storage capacity for oxides of nitrogen. This property is utilized in NOₓ storage or adsorber catalytic converters. Under lean operating conditions (λ>1), the nitric oxides are converted as follows:
2NO+O₂→2NO₂ (Pt catalytic converter)
4NO₂+O₂+2BaCO₃→2Ba(NO₃)₂+2CO₂

Under rich exhaust gas conditions (λ<1), nitrogen dioxide is desorbed back out of the storage and is converted directly with the carbon monoxide present in the exhaust gas, into nitric oxide:
2Ba(NO₃)₂+2CO₂)→4NO₂+O₂+2BaCO₃
2NO₂+4CO→4CO₂+N₂ (Pt, Rh catalyzed)

The switch-over times between lean and rich operation of the engine depend on the quantity of storage material used, the NOₓ emissions and the parameters typical for all catalyzed reactions such as gas throughput and temperature.

Furthermore, regions 2 and/or 3 can include oxygen storage components such as a cerium compound, with the most important substance being the cerium oxide. Oxygen storage components equalize the air ratio fluctuations in λ−1 regulated engines since they can change their oxidation state from +III to +IV and vice versa:
2CeO₂+CO→Ce₂O₃+CO₂→(λ<1)
2Ce₂O₃+O₂→4CeO₂→(λ>1)
In this manner, a constant air ratio is obtained. In addition, cerium supports the noble metal dispersion.

In order to control the temperature resistance of catalytic converter coatings, compounds of the elements La, Zr, etc., preferably as oxides, can also be contained.

The choice of the composition of regions 2, 3, in particular the concentration of noble metal in combination with the noble metal diameter, is closely bound with the particular exhaust gas temperature window to which respective regions 2, 3 are exposed. As a result, the catalytic activity of the regions can be controlled along with other measures. Through a lower concentration of noble metal and/or a larger particle size it is possible first to avoid excessively large conversion immediately after intake into the catalytic converter. As a result, excessively high temperature and loads on the intake side of the catalytic converter can be avoided. Second, it can be provided through the selection of a relatively large concentration of noble metal and of a relatively small particle size that in the downstream region the required activity for conversion of the pollutants is present in sufficient degree, or can even be increased.

Furthermore, the exhaust-gas-side surface of catalytically active coating 1 in the intake region of the NOx storage catalytic converter at least partially has a diffusion layer 4 or is at least partially covered by a diffusion layer 4. The diffusion layer itself essentially contains oxides of aluminum, cerium and/or zirconium and causes a kinetic retardation of the chemical reactions proceeding at this location, in particular transport or diffusion processes. In this manner, temperature peaks (so-called hot spots) are advantageously suppressed in the catalytic converter intake region, and the thermal load in the intake region is reduced, without impairing the cold start behavior of the system.

The manufacture of catalytic converters is well documented in the literature in terms of the general procedure.

By variation of the cell densities (in the intake region of the catalytic converter lower cell densities, for example 200 to 400 cpsi, and in the discharge region of the catalytic converter higher cell densities, for example 600 to 900 cpsi) and the use of conical catalytic converter structures (a narrower catalytic converter diameter in the intake region and an increasing diameter in the discharge region), the sojourn time for the exhaust gas in the different catalytic converter regions can be controlled. That is, in the intake area high flow speeds prevail while in the back region, a longer sojourn time of the exhaust gas and thus a greater conversion plays a role.

FIG. 2 is a schematic representation of an example of a variant according to the invention of a catalytically active coating 1 using the example of a NOₓ storage catalytic converter. (For the sake of simplicity, the same reference characters are used for the same components or components achieving the same function and to this extent reference can be made to the above description for FIG. 1.) In other respects, the advantages mentioned in FIG. 1 and in the general part of the description likewise apply for the embodiment according to the invention in FIG. 2 and for all subsequently mentioned embodiment forms.

The exhaust gas aftertreatment apparatus of FIG. 2 includes a catalytically active coating 1 with at least one region with high light-off temperature and a high temperature resistance 2, and with at least one other region with a low light-off temperature and a reduced temperature resistance 3 in comparison with the at least one region. The region 5, comprising the regions 2 and/or 3, is applied in the manner of a gradient to the catalytic converter support: Within the intake area E of the catalytic converter predominantly the region with high light-off temperature 2 is applied, and in the discharge area A of the catalytic converter predominantly the at least one other region with a low light-off temperature 3 is applied. The exhaust-gas-side surface of the catalytically active coating 1 in the intake region of the NOₓ storage catalytic converter likewise has at least partially a diffusion layer 4, or is at least partially covered by a diffusion layer 4.

FIG. 3 is a schematic representation of an example of a further variant according to the invention, of a catalytically active coating 1 using the example of an NOₓ storage catalytic converter, in the case of which region 3 is provided on the catalytic converter support. The exhaust-gas-side surface of the catalytically active coating 1 in the intake region of the NOₓ storage catalytic converter in like manner also has at least one diffusion layer 4, or is at least partially covered by a diffusion layer 4.

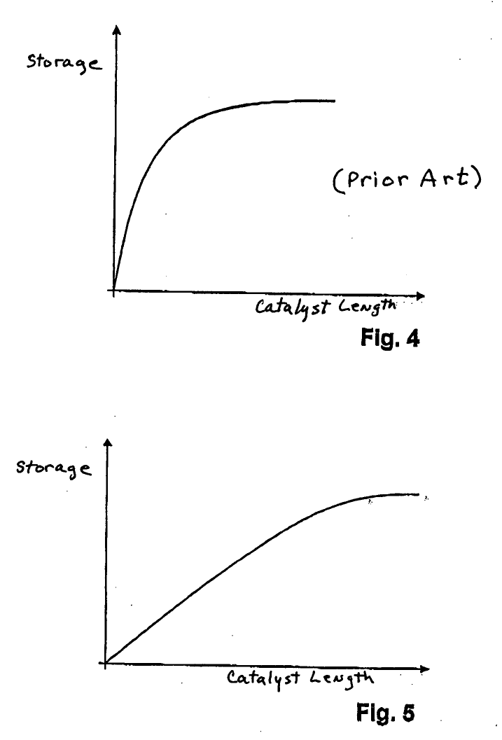

In FIG. 4, the total conversion of a conventional NOₓ storage catalytic converter is plotted as a function of the catalytic converter length. The steep rise of the curve at the beginning clearly shows the high activity of the catalytic converter and the associated high exothermy of the reaction in its intake region. This leads to premature aging or even damage in the intake region of the catalytic converter.

FIG. 5 in contrast demonstrates an optimized conversion behavior, which is retained with all embodiment forms according to the invention. It is possible to utilize the recommended measures for optimization of conversion individually or in combination. Through the invention, the conversion (and above all the associated exothermy, i.e. the quantities of heat released in the catalytic reaction) advantageously are distributed more uniformly on the entire NOₓ storage catalytic converter. The thermic load of the first region of the catalytic converter region is thereby reduced, without impairing the cold-start behavior of the system. In addition, temperature peaks in the intake region are thus effectively avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An exhaust gas cleaning system for an internal combustion engine with at least one catalytically active component, wherein a catalytically active coating of the catalytically active component comprises:
at least a first region with a high light-off temperature and a high temperature resistance; and
at least a second region with a low light-off temperature and a reduced temperature resistance relative to the first region; wherein,
the exhaust-gas-side surface of the catalytically active coating in an intake region of the at least one catalytically active component has at least a partial diffusion layer or is at least partially covered by a diffusion layer.

2. The apparatus according to claim 1, wherein the first region, has a lower specific noble metal content and/or a larger noble metal particle diameter than the second region.

3. The apparatus according to claim 2, wherein:
cell density in the intake region of the catalytically active component is lower than in a discharge region of the catalytically active component.

4. The apparatus according to claim 3, wherein:
the intake region of the catalytically active component is configured with a support material with a high specific heat capacity; and
in its discharge region, the catalytically active component has a support material with low specific heat capacity.

5. The apparatus according to claim 4, wherein:
the catalytically active component has a cone shape.

6. The apparatus according to claim 5, wherein:
the catalytically active coating is multiple layered;
individual layers have a differing composition;
the first region is oriented toward an exhaust-gas side; and
the second region is applied on a side away from the exhaust gas.

7. The apparatus according to claim 6, wherein:
the catalytically active coating is applied in the form of a gradient;
predominantly the region with high light-off temperature is applied in the intake region of the catalytically active component; and
predominantly the second region is applied in the discharge region of the catalytically active component.

8. The apparatus according to claim 5, wherein:
the catalytically active coating has at least predominantly the second region.
